(19) United States
(12) Patent Application Publication
(10) Pub. No.: US 2009/0234759 A1
(43) Pub. Date: Sep. 17, 2009

(54) Auction-Based Security Valuation

(75) Inventors: Frank Hatheway, Chevy Chase, MD (US); Constantine Sokoloff, New York, NY (US)

Correspondence Address: FISH & RICHARDSON PC, P.O. BOX 1022, MINNEAPOLIS, MN, 55440-1022, US

(73) Assignee: The Nasdaq Stock Market, Inc., Rockville, MD (US)

(21) Appl. No.: 12/274,079

(22) Filed: Nov. 19, 2008

Related U.S. Application Data
(60) Provisional application No. 60/989,390, filed on Nov. 20, 2007.

(51) Int. Cl. G06Q 40/00; G06Q 10/00

(52) U.S. Cl. 705/30; 705/37

(57) ABSTRACT

Disclosed are computer-implemented techniques for valuing non-marketable financial instrument such as employee stock options. The techniques include determining a market price of a derivate security that represents exposure to the non-marketable financial instrument by receiving bids or offers at a pre-determined time prior to the start of an auction and determining price information in a computer prior to a scheduled auction close. The determined price information is disseminated to auction participants, and the techniques includes closing the auction and executing on a computer orders and bids for the security at the determined price.

### BACKGROUND

This invention relates to techniques for determining a valuation for securities that do not have an established valuation mechanism.

Organizations such as corporations commonly award employees stock options as part of their compensation to employees. It is generally necessary to ascribe a value to such stock options for inter alia tax purposes.

### SUMMARY

Techniques for using a derivative security that is based on an underlying employee stock option award to determine a fair market price of the underlying employee stock option award are disclosed. The value of the derivative security is determined by market interest in the derivative security and this value of the derivative security may be used to determine the cost of options expenses by analyzing data for discovery of underlying relationships defined by unknown rules. The process uses a technology network that links market participants with a market or exchange, such as Nasdaq OMX, to provide broad access to investors to participate in price discovery for the derivative securities.

According to an aspect of the invention, a computer-implemented method includes determining a market price of a derivate security that represents exposure to an non-marketable financial instrument by, receiving bids or offers at a pre-determined time prior to the start of an auction and determining price information in a computer prior to a scheduled auction close. The method also includes disseminating the determined price information to auction participants and closing the auction and executing on a computer orders and bids for the security at the determined price.

According to an aspect of the invention, a computer program product residing on a computer readable medium for conducting an auction in a security includes instructions for causing a computer to provide a price discovery mechanism for securities by conducting an auction process, by instructions to receive bids and offers at a pre-determined time prior to the start of the auction, determine and disseminate price information, beginning prior to the scheduled auction close, close the auction; and execute orders or bids for the security at a determined price.

According to an aspect of the invention, a memory storing a data structure for use by an application program that administers an employee stock option valuation process with the data structure including a number of security shares and issuer information, orders and bids for the security, price volatility; and an auction price.

The techniques provide fair executions at a single price that is fully reflective of market demand for securities and produces an open process in which all investors have the ability to enter orders and to participate in price discovery.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an auction schematic.

FIG. 2 details an example of the pricing mechanism with 100% vesting and no forfeiture.

FIG. 3 details an example of the pricing mechanism with vested forfeiture.

FIG. 4 details an example of the pricing mechanism with pre-vested forfeiture, alternative A.

FIG. 5 details an example of the pricing mechanism with pre-vested forfeiture, alternative B.

FIG. 6 details an example of the pricing mechanism with partial-vesting forfeiture, alternative A: pure forfeiture.

FIG. 7 details an example of the pricing mechanism with partial-vesting forfeiture, alternative A: mixed forfeiture.

FIG. 8 details an example of the pricing mechanism with partial-vesting forfeiture, alternative B: pure forfeiture.

FIG. 9 details an example of the pricing mechanism with partial-vesting forfeiture, alternative B: mixed forfeiture.

FIG. 10 is a block diagram of a computer system.

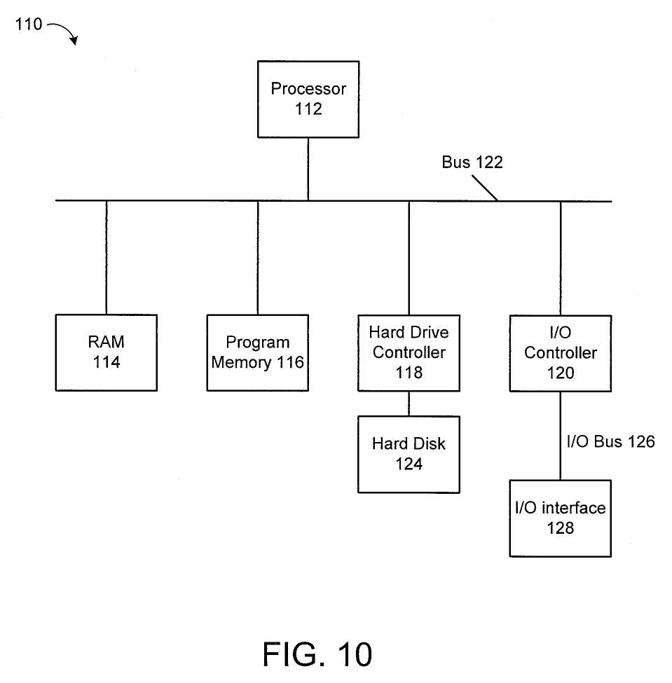

### DETAILED DESCRIPTION

A method, executed in a computer system, provides a liquid and efficient price discovery mechanism for securities, e.g., options, that are based on employee stock option grants, so as to provide investors with market exposure to such employee stock options and to provide a pricing and valuation mechanism for the underlying employee stock options and the like. The method and systems that provide the valuation can be referred to as an “Equity Value Indicator” (EVI) and can be the “NASDAQ Equity Value Indicator Calculator” (NASDAQ EVI Calculator). The method uses an auction process, as described below.

The system distributes all security shares through an execution at the highest price at which all shares can be sold; if all of the securities are not sold, the reserve price, if any, is set, e.g., by the issuer. The method includes a computer system to receive eligible bids and offers for the security through existing market or exchange interfaces, e.g., Nasdaq OMX, NYSE and so forth, for order entry. The system can determine and disseminate an Indicative Auction Price (IAP), e.g., the price at which all securities would be sold, at a time (e.g., ten minutes, thirty minutes, one hour, or more) prior to the execution.

The method can be executed with multiple bids and a single offer, or, alternatively, multiple offers and single bid, multiple bids and multiple offers, or a single bid and a single offer. A delay in the auction can occur if volatility in the security's price is detected.

The security can be an equity security, a debt security, or a derivative security. The security can be registered or unregistered. The security can be listed for secondary trading or unlisted. The security can be previously listed or an original issuance. The security can be a non-marketable or marketable. The securities that are valued using the described systems and methods can be referred to as “Appreciation Rights Securities” Appreciation Rights Securities. One preferred example of a security is described in the following paragraph.

“Non-marketable securities” are those securities that cannot be readily bought or sold. Conventionally, non-marketable securities are characterized as having an undetermined or theoretical price estimated from, for example, a valuation formula. Examples of non-marketable securities include, but are not limited to, employee stock options, restricted share plan awards, performance-based securities benefits plan awards, and stock-appreciation rights awards.

In some embodiments, a security in the auction can be issued by, or on behalf of, a single issuer. Alternatively or in addition, a security in the auction can be purchased by, or on behalf of, a single purchaser. Auction information can include, for example, an IAP that can be based on current bids and offers, paired units that represent the number of units matched for execution at an IAP, and an imbalance and a size of unexecuted units at the IAP.

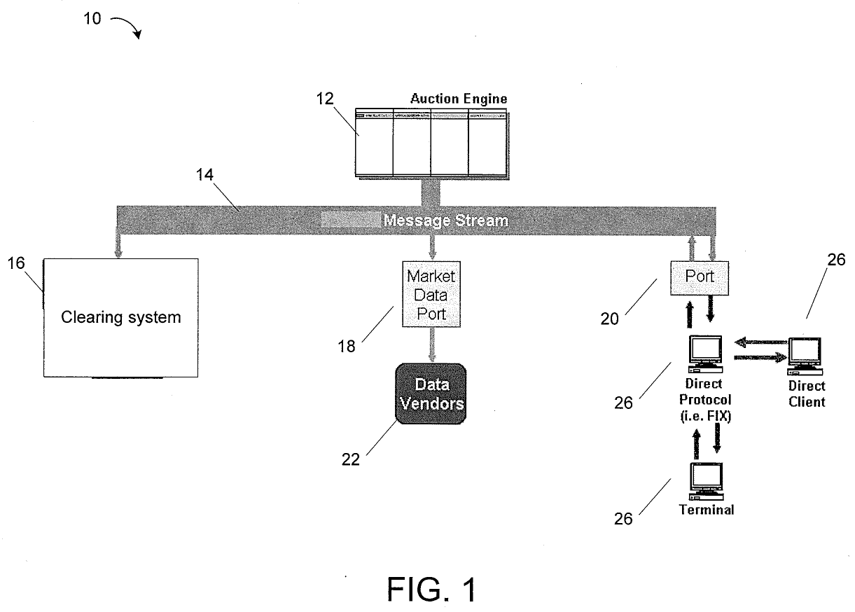

Referring to FIG. 1, an example auction system 10 is shown, which can include an auction engine 12 and a message stream 14 that can be used to connect various components of the auction system 10. In some examples, the message stream 14 connects a clearing system 16 with a market data port 18 and additional ports 20 to the auction system 10. The clearing system 16 can include a system such as the National Securities Clearing Corporation (NSCC) or other clearing systems for securities transactions.

Data vendors (e.g., broker/dealers) access the auction engine 12 by using existing interfaces (e.g., a market data port 18) for order entry. Other users (e.g., investors, corporations) can receive and transfer data to the auction engine 12 by using computers 24 that are connected to port 20, e.g., by a network using an established protocol. The auction information is disseminated through existing market or exchange systems such as the Net Order Imbalance Indicator, which is available via, e.g., a trading platform such as NASDAQTrader.com and a data feed.

In some examples, the system 10 begins accepting bids or offers at a pre-determined time for the start of the auction. The auction information (e.g., IAP information) can be disseminated starting at a specified time (e.g., ten minutes, thirty minutes, one hour, or more) prior to the scheduled auction close. The auction information is updated and posted at regular intervals (e.g., every few seconds, tens of seconds, minute, or minutes). These regular intervals change periodically (e.g., every minute for the first 45 minutes, and every 15 seconds thereafter). Other durations and frequencies of data dissemination are possible.

In some examples, entered orders can be cancelled. Bids and/or offers can be entered until the scheduled time of the auction close and generally executions do not occur prior to the auction close.

At a close of an auction, an execution occurs at a price that is determined as described above. After the close of an auction, final auction information is disseminated to all participants and the execution can clear through a clearing system (e.g., NSCC or other clearing systems for securities transactions). A “quote-only” time period can be extended if the price change is greater than a fixed threshold amount (either absolute or relative) during the pre-defined period prior to the scheduled close of the auction. There can be extensions of the quote-only period for a fixed and known time period in the auction time. In the event of additional price moves, extensions can continue up to a fixed and predetermined number of times. Cancellation can be restricted if the auction is extended more than the predetermined number of times.

Orders can be priced orders or un-priced orders. All orders that are not executed in the auction are cancelled in the absence of secondary market trading. If secondary market trading were to occur, orders not executed could be cancelled or held open for the secondary market.

The execution priority can be determined based on, for example, a price and timestamp of entered bids and/or offers. The execution algorithm determines the price at which the greatest number of securities could be sold without “trading through” any unexecuted limit bids or offers. In the event of multiple prices satisfying this condition, the highest clearing price can be selected in the case of a single seller, or the lowest clearing price in the case of a single buyer. In the case of multiple buyers and sellers or a single buyer and single seller, another benchmark can be selected to ensure a unique clearing price.

### Time Line of Auction Process

The auction system 10 provides users with market exposure to provide a pricing and valuation mechanism for a given security (e.g., employee stock options). The table below depicts rules and fields for the derivative security that is used as part of a technique to discover a valuation for issued employee stock options. These derivative securities can be securities that have a conditional maturity. Their price is determined by supply and demand in the market and the derivative securities are based on the underlying employee stock options. If exercised by investors, the options are settled in cash or alternatively can be settled in shares, e.g., generally common stock in the entity that issued the security. Other shares can be used to settle such as preferred shares, etc.

A number of business days (e.g., one, two, three, or more) after the end of the quarterly reference time period, the Issuer or its agent notifies holders of the security of valuation and/or settlement. Individual units can expire on a specified number of business days after notification. Table 1 depicts various fields that can be used in a data structure to represent the security for a program that administers an employee stock option valuation.

TABLE 1
Fields used in an Auction System

| Field | Rule or Description |
|---|---|
| Issuer | For example, a company or its agent |
| Buyer | Determined by an auction among participant member firms |
| Price | Determined by auction |
| Strike Price | Strike price of corresponding Employee Stock Options (Reference |
| | ESOs). The Board Committee designated to administer Equity Incentive |
| | Plan, in its sole discretion, shall establish the strike price at the time the |
| | Employee Stock Options are granted. |
| Vesting | All ESOs issued can be considered Reference ESOs. Non-vested ESOs |
| | can be handled as described under the Non-Vesting Mechanism. |
| Maturity Type | European or American as described below. |
| Reference Time Period | For example, bi-quarterly, quarterly, yearly. |
| Notification Date | The notification date can be a number of business days after the end of |
| | the Reference Time Period. |
| Notification | An issuer (or their agent) can notify Holders (e.g., via first class mail). |
| Form of Settlement | For example, shares or cash at sole discretion of Issuer (or their agent). |
| Transferability by | Can be unrestricted. Units can be eligible for deposit at a Depository |
| Buyer | Trust Company (DTC) or other clearing agency. |
| Hedging by Buyer | Can be unrestricted. |
| Maturity | The earlier of: |
| | (a) maturity of Reference ESOs at which time units can mature as a |
| | European option or; |
| | (b) at the end of the Reference Time Period, the number of individual |
| | units determined to be mature per the Tranche Structure described below, |
| | can expire a number of business days following the Notification Date, as |
| | an American option |
| Contract size | There can be a number of units (e.g., 100) initially per contract and the |
| | contract size can decrease as units mature. The contracts may not be |
| | divisible by Buyer. |
| Tranche Structure | Each contract has a number of individual units (e.g., 100). Each |
| | Reference Time Period, the Issuer or their agent determines the |
| | percentage of Reference ESOs that have been exercised and forfeited |
| | during the Reference Time Period. A number of Maturing units (which |
| | can be called “Appreciation Rights Securities”) in each contract |
| | corresponding to the percentage of Reference ESOs exercised and |
| | forfeited can then convert to European style settlement. |
| | Using the Rounding Rule, the total percentage of Reference ESOs both |
| | exercised and forfeited is rounded to the nearest whole percentage |
| | following the first reference time period. The number of Maturing units |
| | correspond to that percentage. For subsequent time periods, the number |
| | of Maturing units equal the rounded cumulative percentage of Reference |
| | ESOs both exercised and forfeited as of the end of the period less the |
| | cumulative rounded percentage of Reference ESOs both exercised and |
| | forfeited from the previous period. |
| Rounding Rule | Contracts can round down to the nearest whole percentage for fractional |
| | amounts less than 0.5 percent, and round up to the nearest percentage for |
| | fractional amounts equal to or greater than 0.5 percent. |

### EXAMPLES

### Example 1

### An Auction Mechanism as an Equity Value Indicator

In one example, the auction system 10 provides users with market exposure to provide a pricing and valuation mechanism for a given securities (e.g., employee stock options).

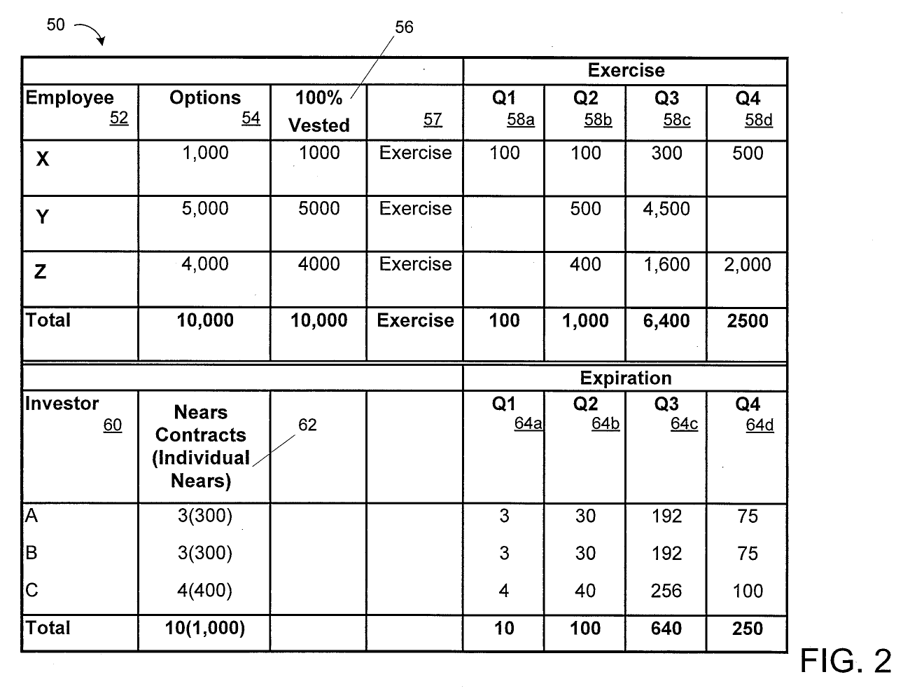

Referring to table 50 in FIG. 2, a column 52 lists three employees: employee X, employee Y, and employee Z. A column 54 lists the number of option units associated with each employee: 1,000 option units for Employee X, 5,000 for Employee Y, and 4,000 for Employee Z. A column 56 lists the number of option units listed in the column 54 that are 100% vested from the beginning of the first quarter. Looking at the total for column 54 and 56, there are a total number of 10,000 options available.

A column 57 lists whether an employee has chosen to exercise or forfeit his options for a given time period (e.g., a quarter). Columns 58a, 58b, 58c, and 58d each list the number of options exercised or forfeited during a specific time period. (In this example, columns 58a-d only list the number of options exercised, but in other examples below, both the number of options exercised and the number of options forfeited are included.) In this example, a percentage of the total number of options exercised during a given time period (e.g., a quarter) by all employees is the number available for purchase. In this example, ten percent of the total number of exercised options will be available for purchase each quarter.

In FIG. 2, 58a corresponds to the first quarter; 58b, the second quarter; 58c, the third quarter; 58d, the fourth quarter. In a first quarter 58a, Employee X exercises 100 of his options, Employee Y exercises none of his options, and Employee Z exercises none of his options. Thus, during the first quarter, a total of 10 options are available for purchase.

A column 60 lists investors A, B, and C, whose number of contracts is listed in column 62 and equal to 3, 3, and 4 contracts, respectfully. Such contracts can be referred to as “Appreciation Rights Securities” contracts. In this example, there are 100 units of “individual Appreciation Rights Securities” per contract, there are a total number of 300, 300, and 400 security units for investors A, B, and C, respectively.

Columns 64a, 64b, 64c, and 64d each list the number of units (e.g., individual Appreciation Rights Securities) purchased during a specific time period. In FIG. 2, 64a corresponds to the first quarter; 64b, the second quarter; 64c, the third quarter; 64d, the fourth quarter. In the first quarter, as shown in column 64a, Investor A purchases 3 units, Investor B purchases 3 units and Investor C purchases 4 units. A total of 10 units are purchased.

As shown in column 58b, in the second quarter, Employee X exercises 100 of his options. Employee Y exercises 500 of his options, and Employee Z exercises 400 of his options. Also shown in column 64b, in the second quarter, Investor A purchases 30 units, Investor B purchases 30 units, and Investor C purchases 40 units. In the third quarter and shown in column 58c, Employee X exercises 300 of his options, Employee Y exercises 4,500 of his options, and Employee Z exercises none of his options. Also in the third quarter and shown in column 64c, Investor A purchases 192 units, Investor B purchases 192 units, and Investor C purchases 256 units. In the fourth quarter and shown in column 58d, Employee X exercises 500 of his options, Employee Y exercises none of his options, and Employee Z exercises none of his options. Also in the fourth quarter and shown in column 64d, Investor A purchases 75 units, Investor B purchases 75 units, and Investor C purchases 100 units. At the end of the fourth quarter, all 10,000 employee options have been exercised and all 10 Appreciation Rights Securities contracts (and 1,000 individual Appreciation Rights Securities units) have been purchased.

Prices for the purchased units can be set by the highest price at which all Appreciation Rights Securities or Appreciation Rights Securities contracts can be sold.

The final auction information (e.g., as determined by auction system 10) can be disseminated to all participants (e.g., by using message stream 14). The execution of purchased units can clear through the clearing system 16 (e.g., NSCC).

### Example 2

### An Auction Mechanism with Forfeiture

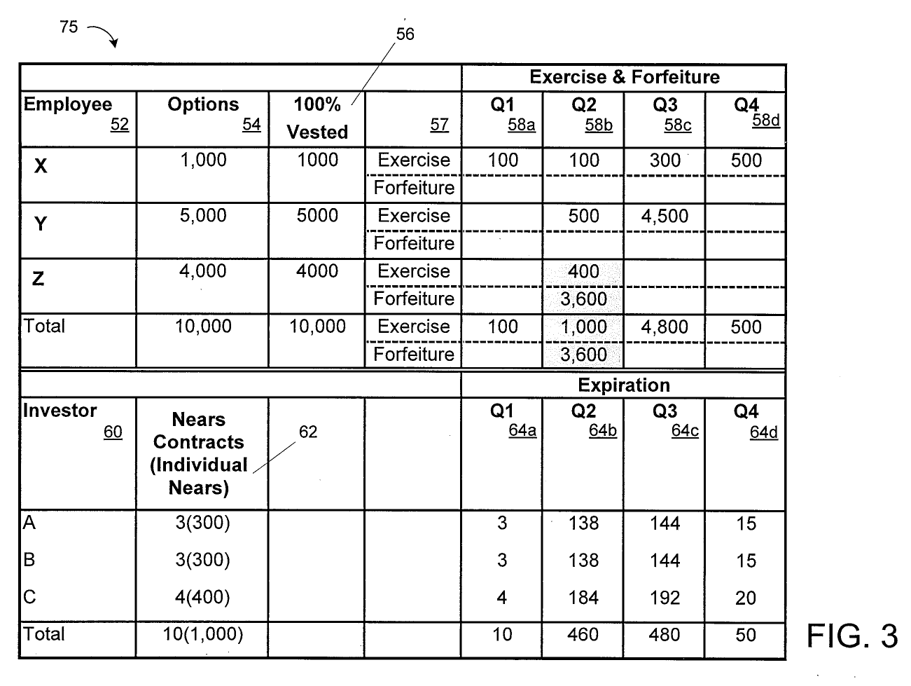

Referring to FIG. 3, a table 75 lists similar data as in the table 50. Employees X, Y, and Z each have the same number of options as in example 1, and all options are 100% vested from the beginning of the first quarter. One difference is that the column 57 in table 75 explicitly lists whether an employee has chosen to exercise or forfeit his options for a given time period (e.g., a quarter). Another difference is that, in this example, a percentage of the total number of options exercised and forfeited during a given time period (e.g., a quarter) by all employees is the number available for purchase.

In this example, as in example 1, ten percent of the total number of exercised and forfeited options will be available for purchase each quarter. In a first quarter 58a, Employee X exercises 100 of his options, Employee Y exercises none of his options, and Employee Z exercises none of his options. In the first quarter, as shown in column 64a, Investors A and B purchase 3 units apiece and Investor C purchases 4 units. Referring to column 58b, in the second quarter, Employee X exercises 100 of his options, Employee Y exercises 500 of his options, and Employee Z exercises 400 and forfeits 3,600 of his options. As shown in column 64b, in the second quarter, Investors A and B each purchases 138 units and Investor C purchases 184 units. In the third quarter and shown in column 58c, Employee X exercises 300 of his options, Employee Y exercises 4,500 of his options, and Employee Z exercises none of his options. Also in the third quarter and shown in column 64c, Investors A and B purchase 144 units apiece and Investor C purchases 192 units. In the fourth quarter and shown in column 58d, Employee X exercises 500 of his options and neither Employee Y nor Employee Z exercises any of his options. Also in the fourth quarter and shown in column 64d, Investors A and B purchase 15 units apiece and Investor C purchases 20 units. At the end of the fourth quarter, all 10,000 employee options have been exercised or forfeited and all 10 Appreciation Rights Securities contracts (and 1,000 individual Appreciation Rights Securities units) have been purchased.

### Example 3

### An Auction Mechanism with Pre-Vesting Forfeiture, Alternative A

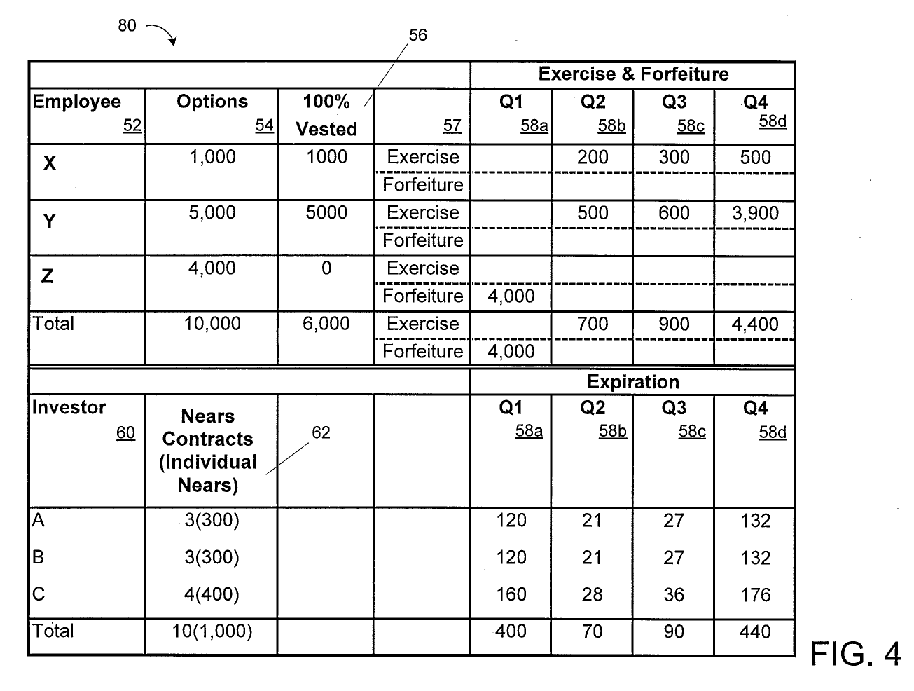

Referring to FIG. 4, a table 80 lists similar data as in the table 75. Employees X, Y, and Z each have the same number of options as in examples 1 and 2. In this example, one difference is that none of Employee Z's options are 100% vested (as listed in the column 56 in the table 80). As such, Employee Z will not be able to exercise any of his 4,000 options. In addition, the options of Employee X and Employee Y do not become 100% vested until the beginning of the second quarter; thus, Employees X and Y can only exercise his options in the second, third, or fourth quarters.

As in example 2, a percentage of the total number of options exercised or forfeited during a given time period (e.g., a quarter) by all employees is the number available for purchase.

In a first quarter 58a, none of Employee X, Employee Y, or Employee Z exercises any of his options. Employee Z, who does not have any vested options and therefore could not exercise any options, forfeits all 4,000 of his options. Employee Z will not participate further in later quarters. Also in the first quarter, as shown in column 64a, Investors A and B purchase 120 units apiece and Investor C purchases 4 units.

As shown in column 58b, in the second quarter, Employee X exercises 200 of his options and Employee Y exercises 500 of his options. Referring to column 64b, in the second quarter, Investors A and B each purchases 21 units and Investor C purchases 28 units. In the third quarter and shown in column 58c, Employee X exercises 300 of his options, Employee Y exercises 4,500 of his options, and Employee Z exercises none of his options. Also in the third quarter and shown in column 64c, Investors A and B purchase 144 units apiece and Investor C purchases 192 units. In the fourth quarter and shown in column 58d, Employee X exercises 500 of his options and neither Employee Y nor Employee Z exercises any of his options. Also in the fourth quarter and shown in column 64d, Investors A and B purchase 15 units apiece and Investor C purchases 20 units. At the end of the fourth quarter, all 10,000 employee options have been exercised or forfeited and all 10 Appreciation Rights Securities contracts (and 1,000 individual Appreciation Rights Securities units) have been purchased.

### Example 4

### An Auction Mechanism with Pre-Vesting Forfeiture, Alternative B

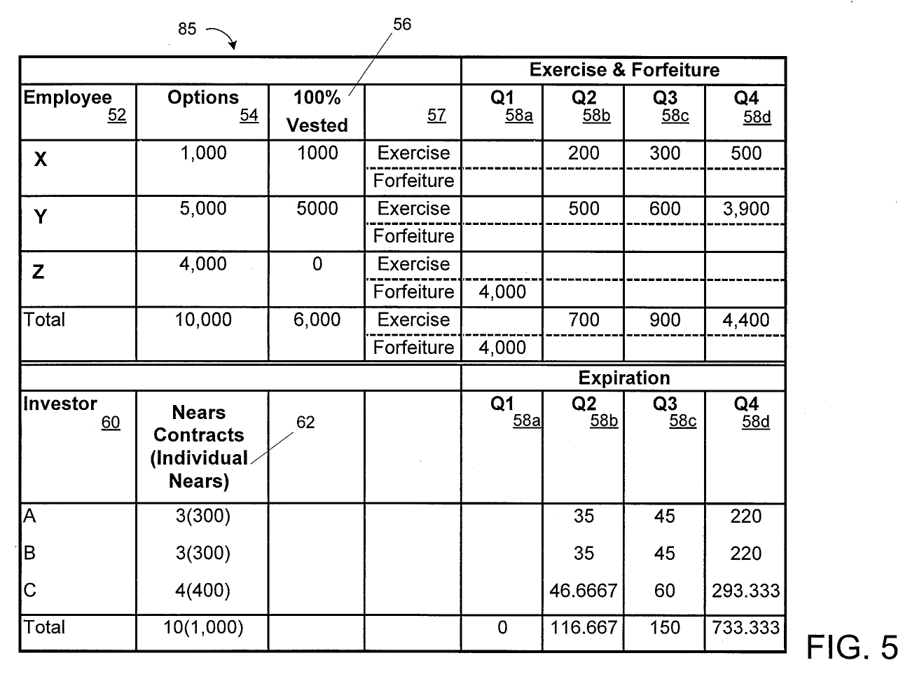

Referring to FIG. 5, a table 85 lists similar data as in the table 80. This example is identical to example 3, except that only a percentage of the total number of options exercised during a given time period (e.g., a quarter) by all employees is the number available for purchase. Thus, no options are available in the first quarter because no options were 100% vested for Employee X, Employee Y, or Employee Z. Investors A, B, and C will divide their individual Appreciation Rights Securities contracts between the second, third, and fourth quarters.

The exercise and forfeiture of options for Employees X, Y, and Z are identical to those for example 3. Referring to column 64b, in the second quarter, Investors A and B each purchases 35 units and Investor C purchases 46.6667 units, which is rounded up to 47 units. In the third quarter and shown in column 64c, Investors A and B purchase 45 units apiece and Investor C purchases 60 units. In the fourth quarter, shown in column 64d, Investors A and B purchase 220 units apiece and Investor C purchases 293.333 units, which is rounded down to 293 units. At the end of the fourth quarter, all 10,000 employee options have been exercised or forfeited and all 10 Appreciation Rights Securities contracts (and 1,000 individual Appreciation Rights Securities units) have been purchased.

### Example 5

### An Auction Mechanism with Partial Vesting Forfeiture and Pure Forfeiture Alternative A

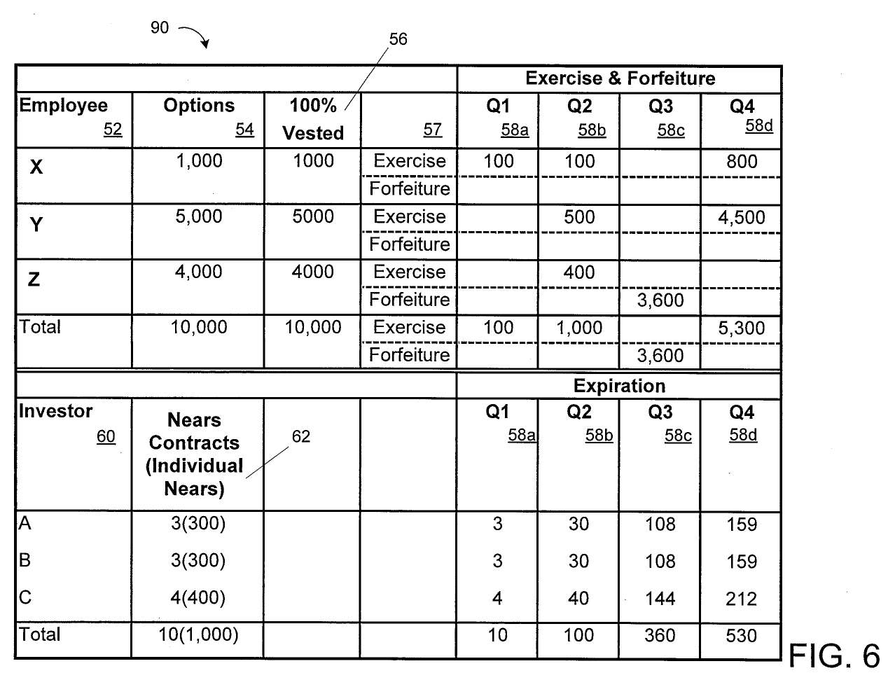

Referring to FIG. 6, a table 90 lists similar data as in the table 75. Employees X, Y, and Z each have the same number of options as in examples 1-4. In this example, one difference is that the options belonging to Employee X, Y, or Z are only 50% vested (as listed in the column 56 in the table 90) for the first, second, and third quarters. The options of Employee X and Employee Y become 100% vested at the beginning of the fourth quarter.

In a first quarter 58a, Employee X exercises 100 options and neither Employee Y nor Employee Z exercises any of his options. Also in the first quarter, as shown in column 64a, Investors A and B purchase 3 units apiece and Investor C purchases 4 units.

As shown in column 58b, in the second quarter, Employee X exercises 100 of his options, Employee Y exercises 500 of his options, Employee Y exercises 400 of his options. Referring to column 64b, in the second quarter, Investors A and B each purchases 30 units and Investor C purchases 40 units. In the third quarter and shown in column 58c, neither Employee X nor Employee Y exercises any of his options, and Employee Z forfeits 3,600 of his options. Also in the third quarter and shown in column 64c, Investors A and B purchase 108 units apiece and Investor C purchases 144 units.

In the fourth quarter and shown in column 56, Employees X and Y have become 100% vested for all of their options. As shown in column 58d, Employee X exercises 800 of his options and Employee Y exercise 4,500 of his options. Also in the fourth quarter and shown in column 64d, Investors A and B purchase 159 units apiece and Investor C purchases 212 units. At the end of the fourth quarter, all 10,000 employee options have been exercised or forfeited and all 10 Appreciation Rights Securities contracts (and 1,000 individual Appreciation Rights Securities units) have been purchased.

### Example 6

### An Auction Mechanism with Partial Vesting Forfeiture and Mixed Forfeiture, Alternative A

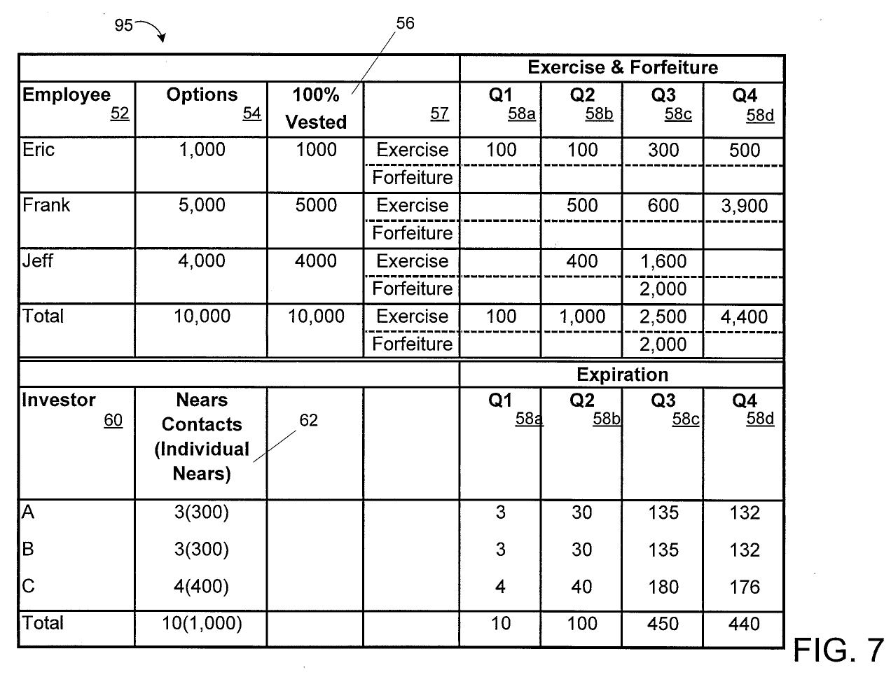

Referring to FIG. 7, a table 95 lists similar data as in the table 90 in example 5. Employees X, Y, and Z each have the same number of options as in examples 1-5. As in example 5, the option of Employees X, Y, and Z are only 50% vested until the beginning of the fourth quarter. The activity during the first and second quarters by Employees X, Y, and Z and Investor A, B, and C is the same as in example 5.

In this example, one difference is that there are two rounds of activity in the third quarter. In a first round of activity in the third quarter, Employee X exercises 300 of his options, Employee Y exercises 600 of his options, and Employee Z exercises 1,600 of his options. Also in the first round of activity in the third quarter, Investors A and B purchase 75 units apiece and Investor C purchases 100 units. During a second round of activity in the third quarter, Employee Z forfeits 2,000 of his options, thus making 200 more options available to investors.

As shown in column 64c, Investors A and B purchase an additional 60 units apiece, for a total of 135 units for the third quarter, and Investor C purchases an additional 80 units, for a total of 180 units for the third quarter.

In the fourth quarter and shown in column 58d, Employee X exercises 500 of his options, Employee Y forfeits 3,900 of his options, and Employee Z does not exercise or forfeit any of his options. Also in the fourth quarter and shown in column 64d, Investors A and B purchase 132 units apiece and Investor C purchases 176 units. At the end of the fourth quarter, all 10,000 Appreciation Rights Securities contracts (and 1,000 individual Appreciation Rights Securities units) have been purchased.

### Example 7

### An Auction Mechanism with Partial Vesting Forfeiture and Pure Forfeiture, Alternative B

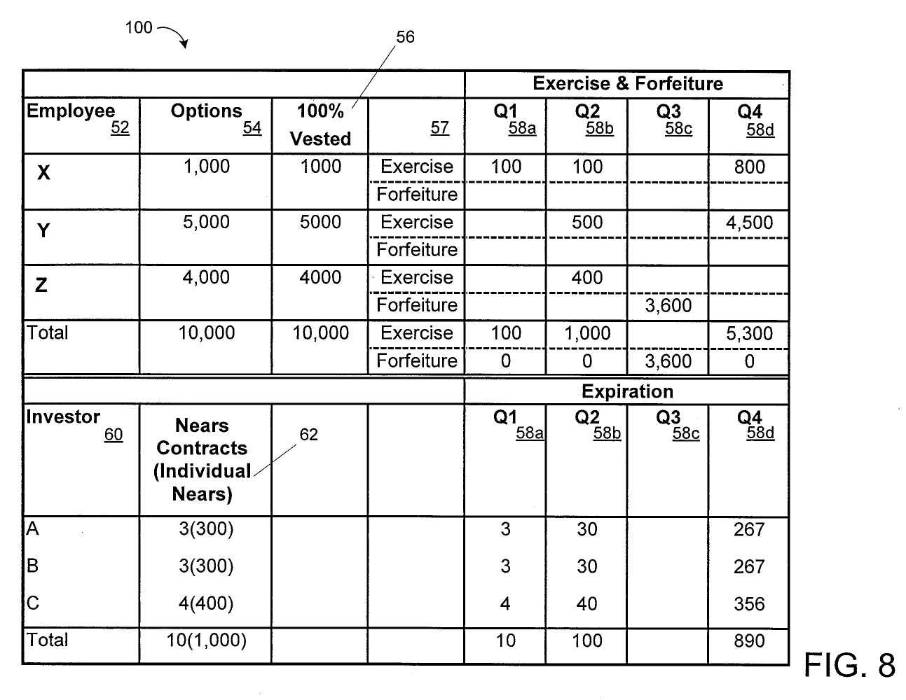

Referring to FIG. 8, a table 100 lists similar data as in the table 90 in example 5. Employees X, Y, and Z each have the same number of options as in examples 1-6. All options of all employees are 100% vested beginning in the first quarter. In this example, a percentage of the total number of options exercised during a given time period (e.g., a quarter) by all employees is the number available for purchase. In this example, ten percent of the total number of exercised options will be available for purchase each quarter.

The activity during the first and second quarters by Employees X, Y, and Z and Investor A, B, and C is the same as in examples 5 and 6. In the third quarter, as shown in column 58c, neither Employee X nor Employee Y exercises or forfeits any of his options, and Employee Z forfeits 3,600 of his options.

In the fourth quarter and shown in column 58d, Employee X exercises 800 of his options, and neither Employee Y nor Employee Z exercises or forfeits any of his options. Also in the fourth quarter and shown in column 64d, Investors A and B purchase 267 units apiece and Investor C purchases 356 units. At the end of the fourth quarter, all 10,000 Appreciation Rights Securities contracts (and 1,000 individual Appreciation Rights Securities units) have been purchased.

### Example 8

### An Auction Mechanism with Partial Vesting Forfeiture and Pure Forfeiture, Alternative B

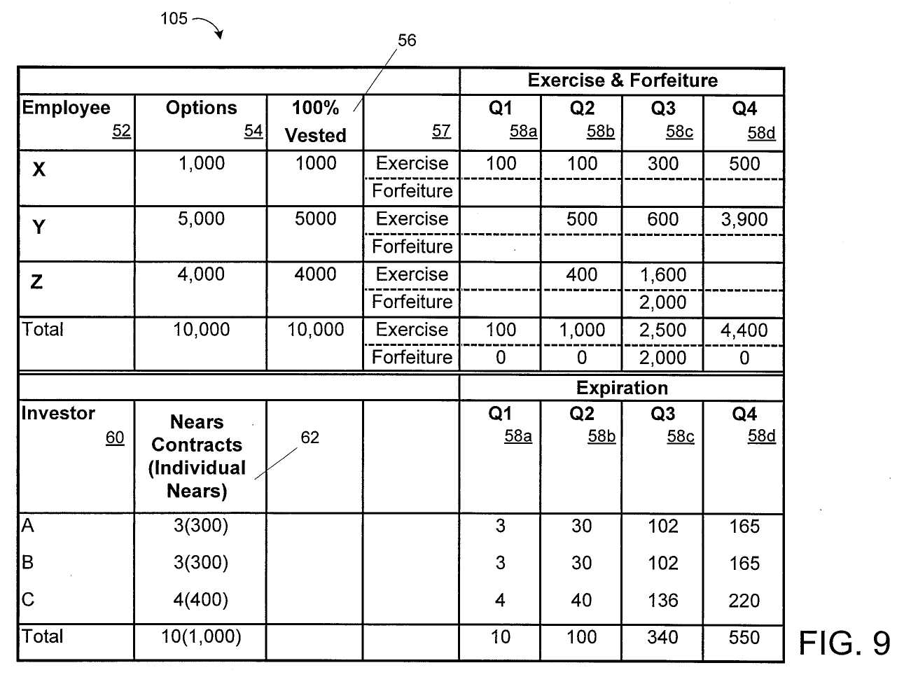

Referring to FIG. 9, a table 105 lists similar data as in the table 90 in example 5. Employees X, Y, and Z each have the same number of options as in examples 1-7. All options of all employees are 100% vested beginning in the first quarter. In this example, a percentage of the total number of options exercised during a given time period (e.g., a quarter) by all employees is the number available for purchase. In this example, ten percent of the total number of exercised or forfeited options will be available for purchase each quarter.

The activity during the first and second quarters by Employees X, Y, and Z and Investor A, B, and C is the same as in examples 5, 6, and 7. In this example, as in example 6, there are two rounds of activity in the third quarter. In a first round of activity in the third quarter, Employee X exercises 300 of his options, Employee Y exercises 600 of his options, and Employee Z exercises 1,600 of his options. Also in the first round of activity in the third quarter, Investors A and B purchase 75 units apiece and Investor C purchases 100 units. During a second round of activity in the third quarter, Employee Z forfeits 2,000 of his options, thus making 200 more options available to investors. Referring to column 64c, Investors A and B purchase an additional 27 units apiece, for a total of 102 units for the third quarter, and Investor C purchases an additional 36 units, for a total of 136 units for the third quarter.

In the fourth quarter and shown in column 58d, Employee X exercises 500 of his options, Employee Y forfeits 3,900 of his options, and Employee Z does not exercise or forfeit any of his options. Also in the fourth quarter and shown in column 64d, Investors A and B purchase 165 units apiece and Investor C purchases 220 units. At the end of the fourth quarter, all 10,000 Appreciation Rights Securities contracts (and 1,000 individual Appreciation Rights Securities units) have been purchased.

Other examples are shown herein.

The invention can be implemented in digital electronic circuitry, or in computer hardware, firmware, software, or in combinations thereof. Apparatus of the invention can be implemented in a computer program product tangibly embodied in a machine-readable storage device for execution by a programmable processor; and method actions can be performed by a programmable processor executing a program of instructions to perform functions of the invention by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor can receive instructions and data from a read-only memory and/or a random access memory. Generally, a computer can include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

One such type of computer includes a programmable processing system suitable for implementing or performing the apparatus or methods of the invention. The system includes a processor, a random access memory (RAM), a program memory (for example, a writable read-only memory such as a flash ROM), a hard drive controller and an input/output (I/O) controller coupled by a processor bus. The system can be preprogrammed, in ROM, for example, or it can be programmed (and reprogrammed) by loading a program from another source (for example, from a floppy disk, a CD-ROM, or another computer). The computer can be a stand-alone computer or a computer server, that is part of a network of such computers as commonly encountered in electronic trading environments.

An example of one such type of computer is shown in FIG. 9, which shows a block diagram of a programmable processing system 110 suitable for implementing or performing the apparatus or methods described herein. The system 110 can include a processor 112, a random access memory (RAM) 114, a program memory 116 (e.g., a writeable read-only memory (ROM) such as a flash ROM), a hard drive controller 118, and an input/output (I/O) controller 120 coupled by a processor (CPU) bus 122. The system 110 can be pre-programmed, in ROM, for example, or it can be programmed (and reprogrammed) by loading a program from another source (for example, from a floppy disk, a CD-ROM, or another computer).

The hard drive controller 118 can be coupled to a hard disk 124 suitable for storing executable computer programs, including programs embodying the present invention, and data including storage. The I/O controller 120 can be coupled to an I/O bus 126 to an I/O interface 128. The I/O interface 128 can receive and transmit data in analog or digital form over communication links such as a serial link, local area network, wireless link, and parallel link.

This application incorporates by reference in their entireties U.S. patent application Ser. No. 10/835,510, filed Apr. 8, 2004 and entitled “Closing In An Electronic Market” and U.S. patent application Ser. No. 11/077,503, filed Mar. 9, 2005 and entitled “Opening Cross in Electronic Market.”

An execution environment includes computers running an operating system and browsers. Other environments could of course be used.

A number of embodiments of the invention have been described. Nevertheless, it can be understood that various modifications may be made without departing from the spirit and scope of the invention. Accordingly, other embodiments are within the scope of the following claims.

What is claimed is:

1. A computer-implemented method comprising:
determining a market price of a derivative security that represents exposure to an non-marketable financial instrument by
receiving bids or offers at a pre-determined time prior to the start of an auction;
determining price information in a computer prior to a scheduled auction close;
disseminating the determined price information to auction participants;
closing the auction and executing on a computer orders and bids for the security at the determined price.

2. The method of claim 1 in which the non-marketable financial instrument is an employee stock option.

3. The method of claim 1 wherein the market price for the security is used to determine a valuation for employee stock options.

4. The method of claim 1 wherein the method receives multiple bids against a single offer.

5. The method of claim 1 wherein the method receives multiple offers and a single bid.

6. The method of claim 1 wherein the method receives multiple bids and multiple offers.

7. The method of claim 1 wherein the method receives a single bid and a single offer.

8. The method of claim 1 further comprising:
recording in a computer settlement of the derivative security based on the number of shares or a cash amount

9. The method of claim 1 wherein the auction information includes a price, paired units, and unexecuted units at a determined price.

10. The method of claim 1 wherein the auction information is disseminated through existing market or exchange systems.

11. The method of claim 1 wherein the auction information is disseminated at a specified time prior to the executing and information is posted at a first rate during a first period.

12. The method of claim 1 wherein an execution priority is determined based on price and timestamp of entered bids or offers.

13. The method of claim 1 wherein an amount of time monitoring prices of the security is increased if a percentage change in the price of the security prior to the release is greater than a threshold value during a predetermined interval prior to a scheduled close of the auction.

14. The method of claim 11, further comprising posting information at a second rate during a second period.

15. An apparatus comprising:
a computing device that is configured to
provide a price-discovery mechanism for securities by conducting an auction process;
receive bids and offers at a pre-determined time prior to the start of the auction;
determine and disseminate the price information, beginning prior to the scheduled auction close;
close the auction; and
execute orders or bids for the security at a determined price.

16. A computer program product residing on a computer readable medium for conducting an auction in a security comprises instructions for causing a computer to:
provide a price discovery mechanism for securities by conducting an auction process;
receive bids and offers at a predetermined time prior to the start of the auction;
determine and disseminate price information, beginning prior to the scheduled auction close;
close the auction; and
execute orders or bids for the security at a determined price.

17. A memory storing a data structure for use by an application program that administers an employee stock option valuation process with the data structure comprising:
a number of security shares and issuer information;
orders and bids for the security;
price volatility; and
an auction price.
